(19) United States
(12) Patent Application Publication
(10) Pub. No.: US 2012/0330739 A1
(43) Pub. Date: Dec. 27, 2012

(54) POINT ASSIGNMENT

(75) Inventors: Sachie Takahashi, Tokyo (JP); Tomoya Matsumoto, Tokyo (JP); Hiroki Takahashi, Tokyo (JP); Naoya Shimizu, Tokyo (JP)

(73) Assignee: NEC BIGLOBE, LTD., Tokyo (JP)

(21) Appl. No.: 13/488,288

(22) Filed: Jun. 4, 2012

(30) Foreign Application Priority Data
Jun. 22, 2011 (JP) 2011-138203

(51) Int. Cl. G06Q 30/02

(52) U.S. Cl. 705/14.27

(57) ABSTRACT

A server includes a database that stores, in association with user identification information for identifying the user who purchases or uses goods or services, the number of points that are assigned to the user according to the purchased or used goods or services and that can be used to purchase goods or services. The server divides the points stored in association with the user identification information into user's own points that only the user can use; and other's points that other users other than the user can use, before storing the points in the database.

This application is based upon and claims the benefit of priority from Japanese Patent Application No. 2011-138203 filed on Jun. 22, 2011, the content of which is incorporated by reference.

### BACKGROUND OF THE INVENTION

1. Field of the Invention

The present invention relates to a communication system assigning service points, a server, and a point assignment method.

2. Description of the Related Art

In recent years, there has been widely accepted in the market a point system in which when a user purchases goods or services from a company such as a retail store and a bank, the user receives points which can be exchanged for goods or services from the company. The purpose of such a point system is primarily to enable a user to retain service points and to promote sales of a company's products/services.

The point system issues points to the user who purchases goods or services.

Alternatively, there has been considered a system in which when a person solicits another person for hotel accommodation, and the solicited person stays in the solicited hotel accommodation, points are added (assigned) to the soliciting person (see Japanese Patent Laid-Open No. 2011-053847).

### SUMMARY OF THE INVENTION

In the above described system, the user has an advantage in that points are added to the user.

Unfortunately, only the user derives an advantage from the above described system which had the disadvantage the points that are retained by the customer due to repeat promotions cannot be used by other users.

It is an object of the present invention to provide a communication system, a server, and a service point assignment method for solving the above described object.

A communication system of the present invention includes a communication terminal that a user operates; and a server including a database that stores, in association with user identification information for identifying the user who purchases or uses goods or services, the number of points that are assigned to the user according to the purchased or used goods or services and that can be used to purchase goods or services, wherein the server divides the points stored in association with the user identification information into the user's own points that only the user can use; and other's points that other users other than the user can use, before storing the points in the database.

A server of the present invention includes a database that stores, in association with user identification information for identifying the user who purchases or uses goods or services, the number of points that are assigned to the user according to the purchased or used goods or services and that can be used to purchase goods or services; and a point operation section that divides the points stored in association with the user identification information into the user's own points that only the user can use; and other's points that other users other than the user can use. before storing the points in the database.

A service point assignment method of the present invention for use in a communication system includes a communication terminal that a user operates; and a server including a database that stores, in association with user identification information for identifying the user who purchases or uses goods or services, the number of points that are assigned to the user according to the purchased or used goods or services and that can be used to purchase goods or services, wherein
the server divides the points stored in association with the user identification information into the user's own points that only the user can use; and other's points that other users other than the user can use, before storing the points in the database.

As described above, the present invention can appeal to a broader range of users.

The above and other objects, features, and advantages of the present invention will become apparent from the following description with reference to the accompanying drawings which illustrate an example of the present invention.

### BRIEF DESCRIPTION OF THE DRAWINGS

FIG. 1 illustrates an exemplary embodiment of a communication system of the present invention;

FIG. 2 illustrates an example of an internal configuration of a server illustrated in FIG. 1;

FIG. 3 illustrates an example of a correspondence between the number of points and user identification information stored in a database illustrated in FIG. 2;

FIG. 4 illustrates an example of a correspondence updated by a point operation section and stored in the database when “A0001” is sent as first user identification information from a communication terminal illustrated in FIG. 1; “B0001” is sent as second user identification information; and “30” points are sent as the number of points to be moved;

FIG. 5 illustrates an example of an internal configuration of the communication terminal illustrated in FIG. 1;

FIG. 6 is a sequence diagram for describing a process of assigning points, of the point assignment method for the communication system illustrated in FIG. 1;

FIG. 7 is a sequence diagram for describing a process of moving the assigned points, of the point assignment method for the communication system illustrated in FIG. 1;

FIG. 8 illustrates an example of an input screen displayed on a display section in step 15;

FIG. 9 illustrates an example of a completion screen displayed on the display section illustrated in FIG. 5;

FIG. 10 illustrates an example of a correspondence indicating a relationship between the friend and the user stored in the database illustrated in FIG. 2; and

FIG. 11 illustrates an example of a user update screen displayed on a display section of the communication terminal to update the relationship between the friend and the user stored in the database illustrated in FIG. 2.

### DETAILED DESCRIPTION OF THE PREFERRED EMBODIMENTS

Now, an exemplary embodiment of the present invention will be described with reference to the accompanying drawings.

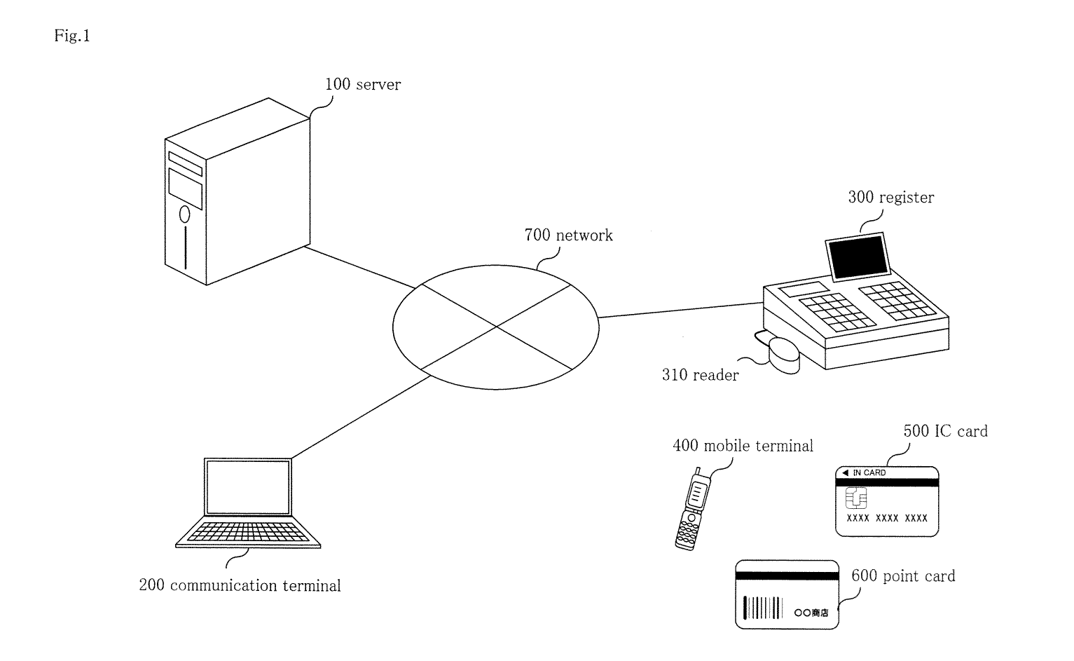

FIG. 1 illustrates a communication system including server 100, communication terminal 200, register 300, mobile terminal 400, IC card 500, point card 600, and network 700 as a communication network.

Server 100 is a communication apparatus that can communicate with communication terminal 200 and register 300 through network 700.

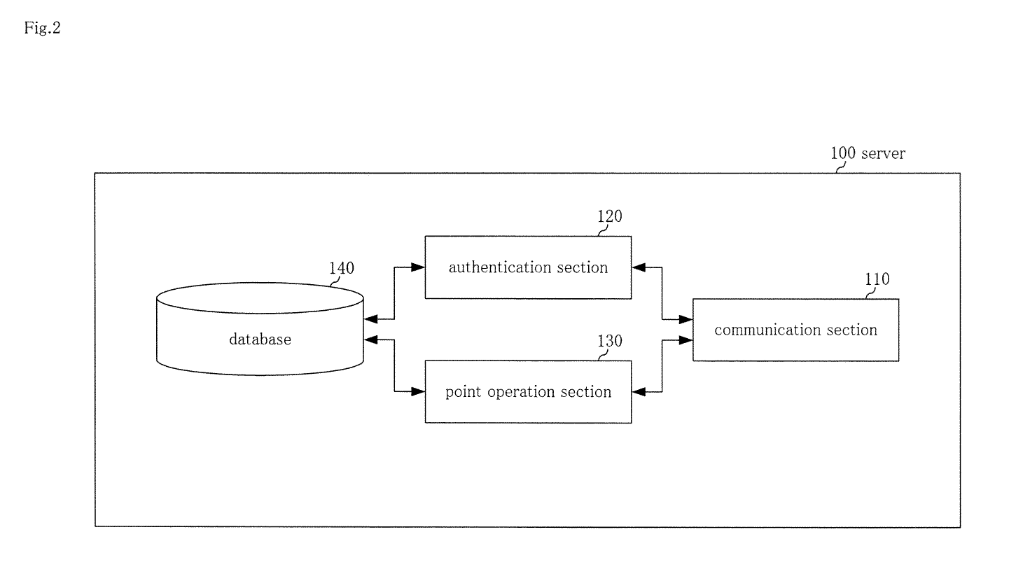

Server 100 illustrated in FIG. 1 includes communication section 110, authentication section 120, point operation section 130, and database 140 as illustrated in FIG. 2. Note that of the components of server 100 illustrated in FIG. 1, FIG. 2 illustrates only the components according to the present invention.

Communication section 110 communicates with communication terminal 200 and register 300 through network 700.

Authentication section 120 authenticates the user based on the user identification information received from communication terminal 200 and register 300 and the user information stored in database 140. The authentication method may be a common method and is not particularly specified here.

When a user purchases or uses goods or services, database 140 stores, in association with user identification information for identifying the user, the number of points that are assigned to the user according to the purchased or used goods or services and that can be used to purchase goods or services. At this time, database 140 divides the points stored in association with the user identification information into the user's own points that only the user can use; and other's points that other users other than the user can use, before storing the points in the database.

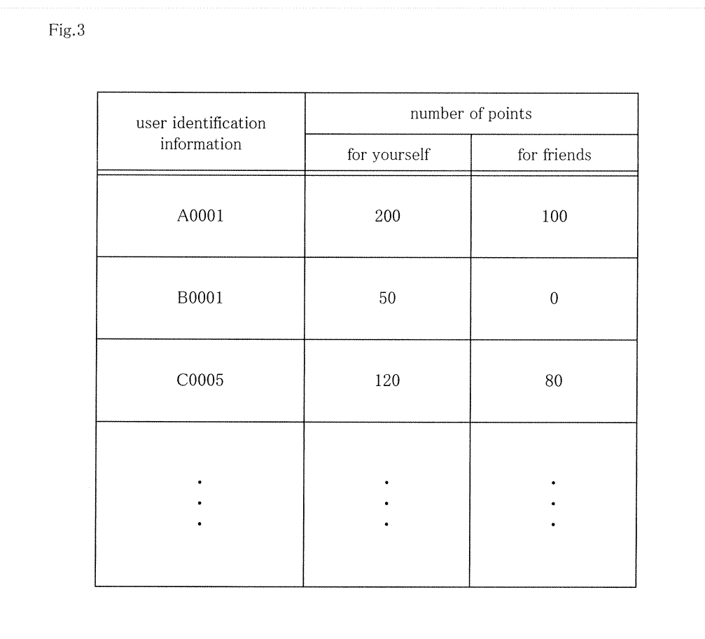

As illustrated in FIG. 3, the user identification information is stored in database 140 illustrated in FIG. 2 in association with the number of points.

The user identification information is identification information that can identify the user and is assigned specifically to the user. Examples of the user identification information may include the login ID used by the user to log in to the system, or the name or nick name converted based on the identification information.

When a user purchases or uses goods or services, the number of points is assigned to the user according to the purchased or used goods or services and can be used to purchase goods or services.

As illustrated in FIG. 3, the number of points is classified into points “for yourself” and points “for friends”. The points “for yourself” are the user's own points that the user can use. The points “for friends” are other's points that the user cannot use, but a friend of the user other than the user can use.

For example, as illustrated in FIG. 3, user identification information “A0001” is stored in association with your number of points “200” and your friend's number of points “100”. This indicates that the number of points obtained by the user with user identification information “A0001” is 300 (=200+100) points; of this number of points, the number of points that can be used by the user “A0001” is 200 points and the number of points that can be used by a friend of the user “A0001” is 100 points. Further, user identification information “B0001” is stored in association with your number of points “50” and your friend's number of points “0”. This indicates that the number of points obtained by the user with user identification information “B0001” is 50 points; of this number of points, the number of points that can be used by the user “B0001” is 50 points and the number of points that can be used by a friend of the user “B0001” is 0 points. Furthermore, user identification information “C0005” is stored in association with your number of points “120” and your friend's number of points “80”. This indicates that the number of points obtained by the user with user identification information “C0005” is 200 (=120+80) points; of this number of points, the number of points that can be used by the user “C0005” is 120 points and the number of points that can be used by a friend of the user “C0005” is 80 points.

Database 140 stores information (such as user identification information and a password) that required to authenticate the user. Point operation section 130 update the correspondence stored in database 140.

When the points according to the purchases of goods or services by the user are stored in database 140, point operation section 130 divides the points stored in association with the user identification information into the user's own points and the other's points before storing the points in database 140. At this time, point operation section 130 divides the points into the user's own points and other's points based on a predetermined ratio or the number of points.

When communication terminal 200 requests point operation section 130 to move at least some points from among the number of points of other's points stored in database 140 in association with the first user identification information to the user's own points associated with second user identification information, point operation section 130 moves the number of points that are required to be moved, from the other's points associated with the first user identification information to the user's own points associated with the second user identification information before storing the number of points in database 140. At this time, when the first user identification information, the second user identification information, and the number of points to be moved are received from communication terminal 200, point operation section 130 subtracts the received number of points from the number of points of the other's points associated with the first user identification information in database 140, and then stores the number of resultant points in database 140 as the other's points associated with the first user identification information. Further, point operation section 130 searches database 140 for the received second user identification information. If the second user identification information is found in database 140, point operation section 130 adds the received number of points to the number of points of the user's own points associated with the found second user identification information and stores the number of resultant points in database 140. If the received second user identification information is not found in database 140, point operation section 130 stores the second user identification information and the received number of points in database 140 in association with the user's own points.

With reference to a specific example, a further detailed description will be given.

For example, the correspondence illustrated in FIG. 3 is assumed to be stored in database 140. At this time, communication terminal 200 sends “A0001” as the first user identification information, “B0001” as the second user identification information, and “30” points as the number of points that are to be moved. Then, point operation section 130 searches database 140 for “A0001”. Then, point operation section 130 subtracts the “30” points from the number of points for others (for friends) associated with “A0001”. Currently, the number of points for others (for friends) associated with “A0001” is “100”. Accordingly, a calculation (100−30) is made. As a result, the “70” points are stored as the number of points for others (for friends) associated with “A0001”. Further, point operation section 130 searches database 140 for “B0001”. Then, point operation section 130 adds “30” to the number of points of the user's own points associated with “B0001”. Currently, the number of points of the user's own points associated with “B0001” is “50”. Accordingly, a calculation (50+30) is made. As a result, the “80” points are stored as the number of points of the user's own points associated with “B0001”.

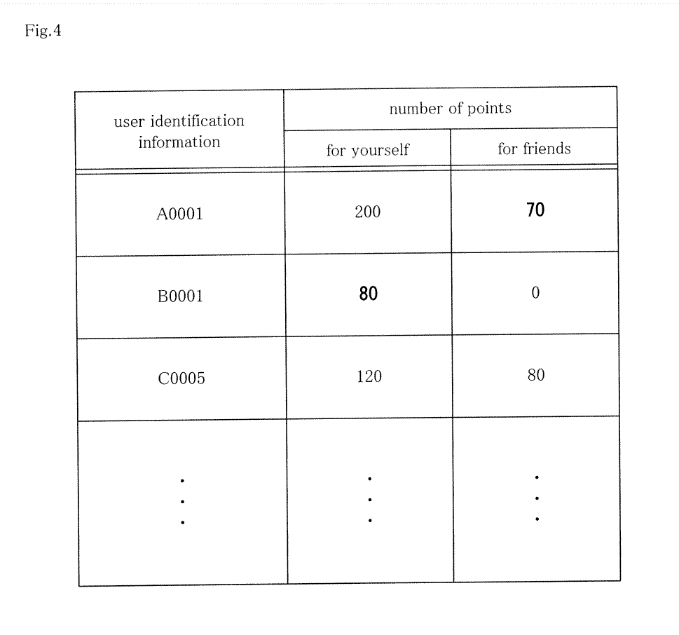

In comparison with FIGS. 3 and 4, the number of points for friends with user identification information “A0001” is updated from “100” to “70” (indicated in bold). Further, the number of points of the user's own points with user identification information “B0001” is updated from “50” to “80” (indicated in bold).

Communication terminal 200 is a communication apparatus that the user operates.

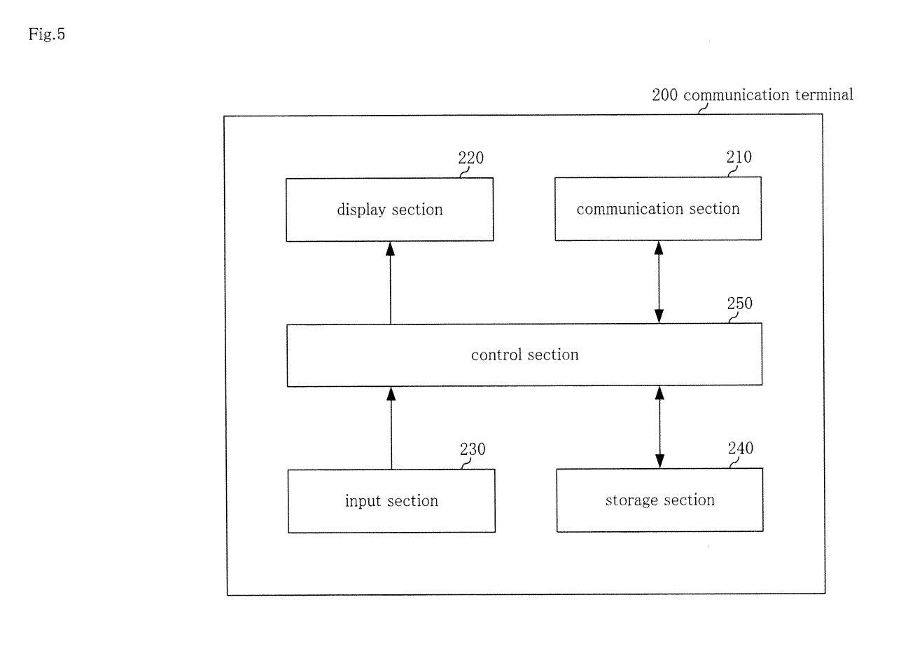

Communication terminal 200 illustrated in FIG. 1 includes communication section 210, display section 220, input section 230, storage section 240, and control section 250 as illustrated in FIG. 5.

Communication section 210 communicates to and from server 100 through network 700.

Display section 220 is display for displaying information.

Input section 230 is a keyboard, a mouse, a touch panel, and the like for inputting information from the outside.

Storage section 240 stores predetermined information. For example, storage section 240 stores user identification information.

Control section 250 controls entire communication terminal 200 including these components.

Control section 250 issues a request to server 100 through communication section 210 so as to move at least some of the number of points of the other's points stored in database 140 of server 100 in association with the first user identification information, to the user's own points associated with the second user identification information according to a predetermined instruction. At this time, control section 250 makes a request to move the points by sending, to server 100, the first user identification information, the second user identification information, and the number of points that are to be moved. Here, the “predetermined instruction” may be a preset instruction, an instruction inputted to input section 230 from outside, or an instruction that contains the second user identification information from the user. The first user identification information to be sent may be information preliminarily stored in storage section 240 or information inputted to input section 230 from the outside. The second user identification information and the number of points to be sent may be information inputted to input section 230 from the outside.

Register 300 is a checkout machine installed in a store and the like. When a user purchases goods or services, register 300 sends, to server 100, the number of points according to the purchased goods or services or the price thereof. At this time, register 300 sends the number of points together with the user identification information of the user to server 100. The user identification information may be information read from IC card 500 or point card 600 in which the user identification information is stored, or information read from mobile terminal 400. Further, the user identification information may be information read from mobile terminal 400 or the like using reader 310 having a non-contact communication function provided in register 300. Reader 310 may be such that, for example, when mobile terminal 400 is passed over reader 310, reader 310 reads the user identification information from mobile terminal 400.

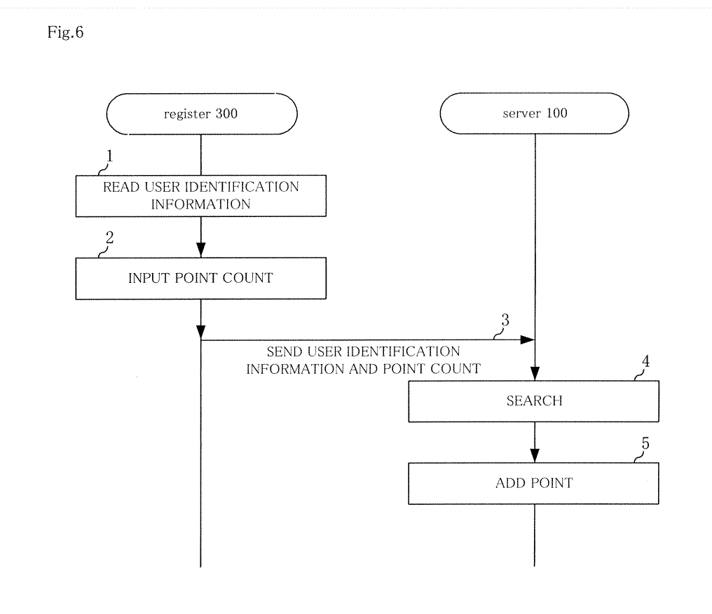

Now, the point assignment method for the communication system illustrated in FIG. 1 will be described. First, as regards the point assignment method for the communication system illustrated in FIG. 1, a process of assigning points will be described with reference to FIG. 6.

First, a user purchases goods or services. Then, in step 1, at settlement, the user identification information is read from mobile terminal 400. IC card 500, or point card 600 by reader 310 of register 300. Then, in step 2, the number of points according to the purchased goods or services or the price thereof is inputted to register 300. Then, in step 3, the user identification information and the number of points are sent from register 300 to server 100.

Note the process in step 1 or the process in step 2, whichever comes first.

When communication section 110 of server 100 receives the user identification information and the number of points from register 300, then in step 4, point operation section 130 searches database 140 for the corresponding user identification information.

If the user identification information is found in database 140, then in step 5, the number of points received from register 300 is added to the number of points stored in association with the found user identification information. At this time, the number of points is divided into the user's own points and the other's points based on a preset ratio or the number of points and stored in database 140.

Note that the number of points may be assigned not when a user purchases goods or services but when the user visits the store. For example, a point may be assigned just when the user enters the store. Here, the system may recognize that the user enters the store such that, for example, when the user passes his or her mobile terminal 400, IC card 500. or point card 600 over a reader installed in the store separately from register 300, the reader reads the user identification information from the terminal or the card and sends the information to server 100. Alternatively, the system may recognize that the user enters the store such that if mobile terminal 400 has a GPS (Global Positioning System) function, mobile terminal 400 obtains the position information and sends the obtained position information and the user identification information to server 100; and then based on the position information, server 100 determines whether or not the user holding mobile terminal 400 has entered the store.

Still alternatively, a predetermined point may be assigned according to a user action such as answering a questionnaire on the Internet. Thus, any method may be used as long as the user can be identified and points can be assigned to the user.

If a user purchases goods or services in a site on the Internet, the user needs to settle the transaction on the Internet because there is no register 300. In this case, the user identification information and the number of points may be sent to server 100 from the site where the user made the settlement. The point may be sent by a common method and is not particularly specified. The user identification information at this time is the information that the user inputs to a communication terminal connected to the Internet.

Apparently, such points may be classified for each store and site (for example, in association with the store identification information for identifying the store) and stored in database 140.

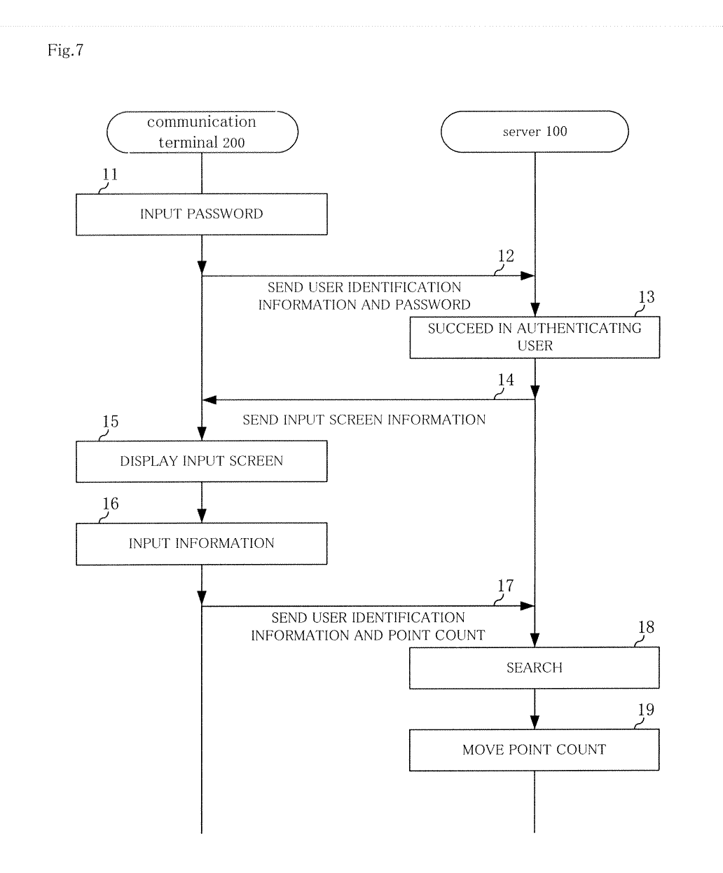

Next, as regards the point assignment method for the communication system illustrated in FIG. 1, a process of moving the assigned point will be described with reference to FIG. 7.

First, in step 11, a password is inputted to input section 230 of communication terminal 200. Then, in step 12, the user identification information (first user identification information) inputted to input section 230 or stored in storage section 240 and the inputted password are sent from communication section 210 to server 100.

When communication section 110 of server 100 receives the user identification information and the password from communication terminal 200, then in step 13, authentication section 120 authenticates the user based on the received information and password and the information stored in database 140. This authentication method may be a common method.

If authentication section 120 succeeds in authenticating the user, input screen information is generated using the user identification information and other's number of points stored in database 140 in association with the user identification information. Then, in step 14, the generated input screen information is sent from communication section 110 to communication terminal 200.

When communication section 210 of communication terminal 200 receives the input screen information from server 100, then in step 15, an input screen is displayed on display section 220 based on the received input screen information.

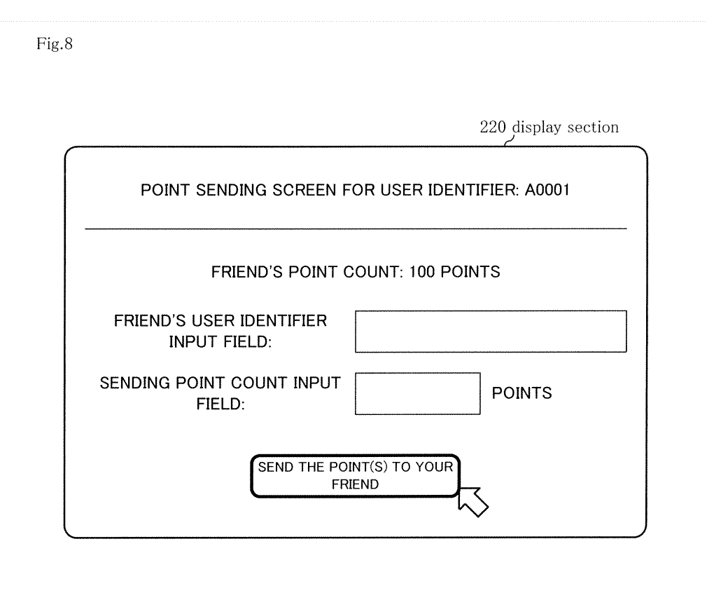

When a correspondence illustrated in FIG. 3 is stored in database 140, then in step 15, an input screen is displayed on display section 220 as illustrated in FIG. 8. As illustrated in FIG. 8, the input screen includes the first user identification information “A0001”; the friend's number of points “100” as the other's points associated with “A0001”; an input field for inputting the friend's user identification information (second user identification information) to which you want to move the point; and an input field for inputting the number of points that are to be moved (sent).

Then, in step 16, the second user identification information is inputted to the input field of the friend's user identification information, and the number of points is inputted to the input field of the number of points that are to be moved (sent). When the button “send the point to your friend” is selected, then in step 17, the first user identification information, the inputted second user identification information, and the inputted number of points are sent from communication section 210 to server 100. For example, when “B0001” is inputted to the input field of the second user identification information and “30” is inputted to the input field of the number of points that are to be moved, the first user identification information “A0001”, the second user identification information “B0001”, and the number of points “30” are sent from communication section 210 to server 100.

Here, if a value greater than the friend's number of points displayed on display section 220 as the number of points to be moved, a message indicating that the input cannot be accepted or a message prompting reentry may be displayed on display section 220.

Alternatively, when information is inputted to an input field of the friend's user identification information, the friend's information registered in an SNS (Social Networking Service) may be read separately, the friend may be selected from a list of friends stored in storage section 240 or database 140 of server 100, or the name or nickname will be used as a keyword to search storage section 240 or database 140 of server 100.

When communication section 110 of server 100 receives the first user identification information, the second user identification information, and the number of points from communication terminal 200, then in step 18, point operation section 130 searches database 140 for the received first user identification information “A0001”. If found, point operation section 130 obtains the friend's number of points “100” associated with the found user identification information “A0001”. Then, point operation section 130 subtracts, from the number of points “100”, the number of points “30” received from communication terminal 200. Further, point operation section 130 searches database 140 for the received second user identification information “B0001”. If found, point operation section 130 obtains the user's own number of points “50” associated with the found user identification information “B0001”. Then, point operation section 130 adds, to the number of points “50”, the number of points “30” received from communication terminal 200. Thus, in step 19, the number of points “30” is moved from the friend's points of “A0001” to the user's own points of “B0001”. As a result of moving these points, the correspondence stored in database 140 is updated to the correspondence illustrated in FIG. 4.

Subsequently, the results of point movement may be sent from server 100 to communication terminal 200. For example, the completion screen information for displaying a completion screen indicating the results may be sent from server 100 to communication terminal 200. The completion screen information includes the first user identification information “A0001”; the second user identification information “B0001”; the moved number of points “30”; and other's number of points (friend's number of points) “70” associated with the first user identification information after the points have been moved.

When communication section 210 of communication terminal 200 receives the completion screen information from server 100, a completion screen is displayed on display section 220 based on the received completion screen information.

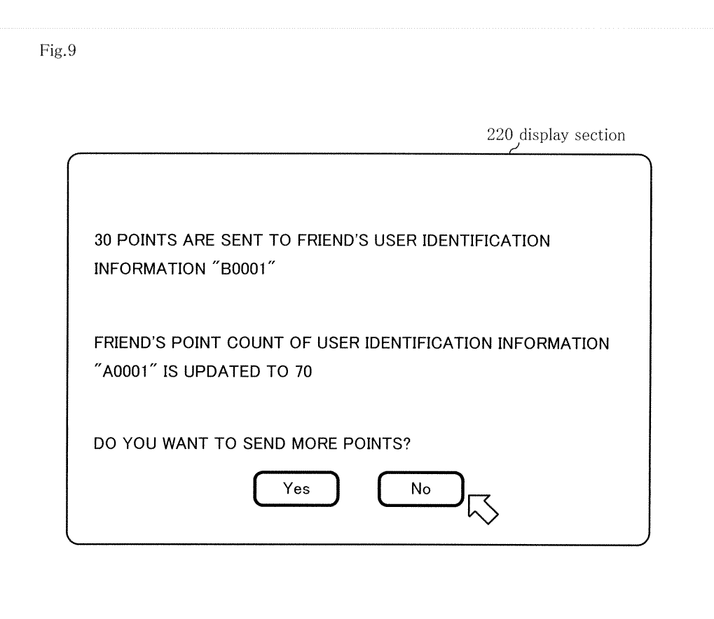

As illustrated in FIG. 9, display section 220 illustrated in FIG. 5 includes a message indicating that 30 points have been moved (sent) to user identification information “B0001” and a message indicating that the friend's number of points of user identification information “A0001” have been updated to 70. Further, display section 220 may include a Yes button and a No button as to whether or not to move (send) points. If the Yes button is selected, the input screen illustrated in FIG. 8 may be displayed again.

Further, at this time, a message may be sent to the destination to which the points have been moved. For example, in the above described example, a message indicating that 30 points have been moved may be sent to a communication terminal of user identification information “B0001”. At this time, display section 220 may include a message indicating the total number of points that have been moved or a message indicating the source from which the points have been received. For example, when an email address is preliminarily stored in database 140 in association with the user identification information, an email message to that effect may be sent to the email address.

Alternatively, database 140 illustrated in FIG. 2 may include a correspondence indicating a relationship between the friend and the user.

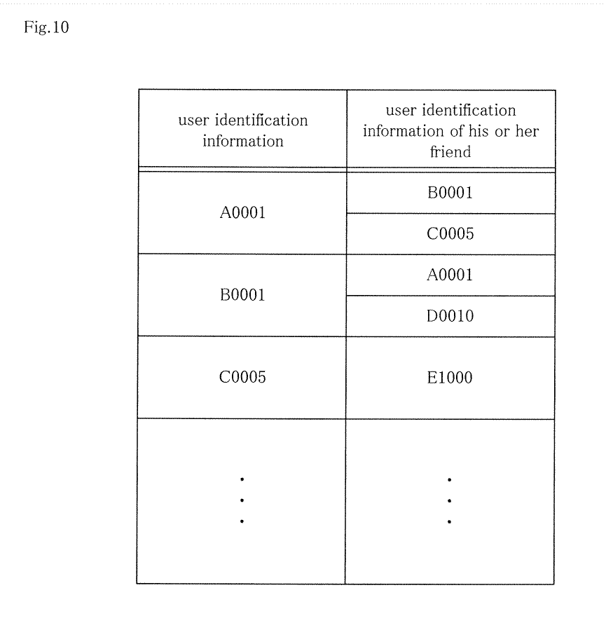

Database 140 illustrated in FIG. 2 includes user identification information and user identification information of his or her friend in association with each other as illustrated in FIG. 10. The user identification information corresponds to the first user identification information; and the user identification information of his or her friend corresponds to the second user identification information.

For example, as illustrated in FIG. 10, user identification information “A0001” is stored in association with the friend's user identification information “B0001” and “C0005”. More specifically, the user registered as a friend of the user having user identification information “A0001” includes a user having user identification information “B0001” and a user having user identification information “C0005”. Further, user identification information “B0001” is stored in association with friend's user identification information “A0001” and “D0010”. This indicates that the user registered as a friend of the user having user identification information “B0001” includes the user having user identification information “A0001” and a user having user identification information “D0010”. Furthermore, user identification information “C0005” is stored in association with friend's user identification information “E1000”. This indicates that the user registered as a friend of the user having user identification information “C0005” includes the user having user identification information “E1000”.

The correspondence indicating the friend relationship registered in database 140 can be updated from communication terminal 200.

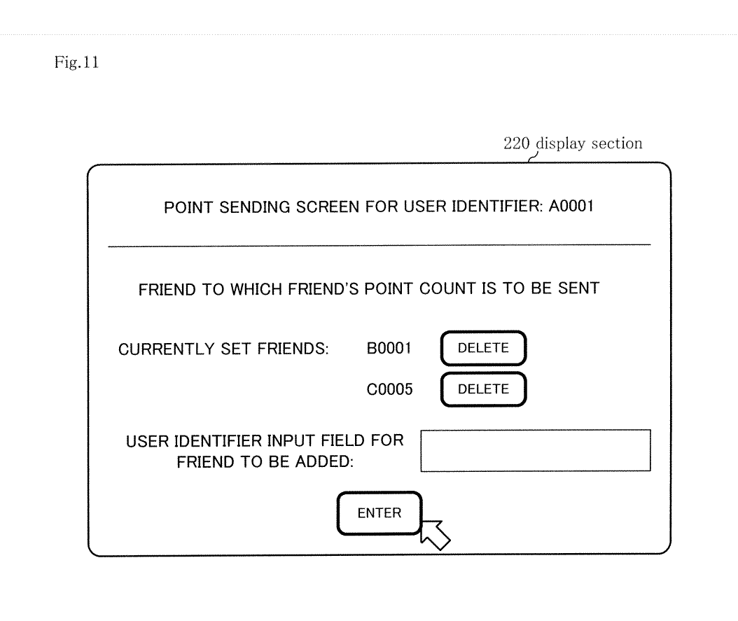

Now, the description will focus on the process of updating the friend relationship registered in database 140 illustrated in FIG. 2. For example, as illustrated in FIG. 11, a user update screen for the user having user identification information “A0001” is displayed on display section 220 of communication terminal 200 that the user having the user identification information “A0001” operates as illustrated in FIG. 11.

The displayed user update screen includes a list of user identification information currently registered as friends in database 140, in which each friend has a deletion button to delete the corresponding information. The user update screen further includes an entry field for inputting user identification information of a friend who is to be added; and an enter button.

In the above example, the user having the first user identification information moves the points by specifying the second user identification information as the destination to which other's points of the user having the first user identification information are to be moved, but the user having the second user identification information may move the points by himself or herself. For example, the points may be moved such that the first user identification information and the number of points of other's points are sent to a user belonging to a certain group (such as a user registered as a friend as illustrated in FIG. 10, hereinafter referred to as a friend user) by email, electronic bulletin board, or the like; from among the friend users, a user wanting to get some or all of the other's points may perform a process of moving the assigned points and requests that the assigned points be moved; and then, the points are moved from the other's points associated with the first user identification information to the user's own points associated with the second user identification information as the user identification information of the friend user.

Alternatively, the points may be moved such that when a user purchases goods or services and points are added to other's points associated with the first user identification information, the other's points may be moved to the user's own points associated with the second user identification information based on a predetermined ratio or the number of points. For example, an assumption is made that the friend relationship as illustrated in FIG. 10 is registered in database 140 and that the percentage of points that have been moved to “B0001” associated with user identification information “A0001” has been registered in advance as 60% and that the percentage of points that have been moved to “C0005” has been registered as 40%. In this case the points may be moved such that when the user “A0001” purchases goods or services and communication section 110 receives the user identification information “A0001” and the number of points, point operation section 130 assigns 100 points to other's points of “A0001” and searches database 140 for the relationship between the friend and user of “A0001” and the percentage of assigning the points; and then moves 60 points as 60 percentage points of the 100 points to the user's own points of “B0001” and moves 40 points as 40 percentage points thereof to the user's own points of “C0005”.

Thus, according to the present invention, points obtained by a user can be useful to others such as friends and can further promote the visit of friends of the user to use the points in the store, whereby the number of customers can be increased.

The process of each component provided in server 100 may be performed by a logic circuit fabricated according to the purpose. Further, the process may be performed such that a computer program in which the processing content is written as a procedure (hereinafter referred to as a program) is recorded in a recording medium readable by server 100 and the program recorded in the recording medium is read and executed by server 100. Examples of the recording medium readable by server 100 include movable recording media such as a floppy (registered trademark disk, a magneto-optical disk, a DVD, and a CD as well as a memory such as a ROM and a RAM and an HDD stored in server 100. The program recorded in the recording medium is read by a CPU (not illustrated) provided in server 100 and the same processing as that described above is performed under the control of the CPU. Here, the CPU operates as a computer for executing the program read from the recording medium in which the program is recorded.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A communication system comprising: a communication terminal that a user operates; and a server including a database that stores, in association with user identification information for identifying the user who purchases or uses goods or services, a number of points that are assigned to the user according to the purchased or used goods or services and that can be used to purchase goods or services, wherein
said server divides the points stored in association with the user identification information into user's own points that only the user can use; and other's points that other users other than the user can use, before storing the points in said database.

2. The communication system according to claim 1, wherein
said communication terminal issues a request to said server to move at least some points from among the number of points of other's points stored in said database in association with first user identification information to the user's own points associated with second user identification information based on a predetermined instruction, and
when the movement request is received from said communication terminal, said server moves the number of points for which a move request has been made from the other's points associated with the first user identification information to the user's own points associated with the second user identification information to be stored in said database.

3. The communication system according to claim 2, wherein
when issuing the request, said communication terminal sends, to said server, the first user identification information, the second user identification information, and the number of the points to be moved, and
said server subtracts the number of the received points from the number of points of the other's points received from said communication terminal and associated with first user identification information and stores the number of resultant points in said database as the other's points associated with the first user identification information; said server searches said database for second user identification information received from said communication terminal; if the second user identification information is found in said database, said server adds the number of points received from said communication terminal to the number of points of the user's own points associated with the found second user identification information; said server stores the number of resultant points in said database as the user's own points associated with the second user identification information; and if the second user identification information is not found in said database, said server stores the second user identification information and the number of points received from said communication terminal in said database as the user's own points in association with each other.

4. The communication system according to claim 2, wherein
said communication terminal requests to move at least some of the number of points of the other's points stored in said database in association with the first user identification information to the user's own points associated with the second user identification information based on a preset instruction.

5. The communication system according to claim 2, wherein
said communication terminal makes a request to move at least some of the number of points of the other's points stored in said database in association with the first user identification information to the user's own points associated with the second user identification information based on an instruction inputted to said communication terminal.

6. The communication system according to claim 2, wherein
said communication terminal makes a request to move at least some of the number of points of the other's points stored in said database in association with the first user identification information to the user's own points associated with the second user identification information based on an instruction from a user having the second user identification information.

7. A server comprising:
a database that stores, in association with user identification information for identifying the user who purchases or uses goods or services, the number of points that are assigned to the user according to the purchased or used goods or services and that can be used to purchase goods or services; and
a point operation section that divides the points stored in association with the user identification information into user's own points that only the user can use; and other's points that other users other than the user can use, before storing the points in said database.

8. The server according to claim 7, wherein
when a request is made from a communication terminal that the user move at some of the number of points of the other's points stored in said database in association with first user identification information to the user's own points associated with second user identification information, said point operation section moves the number of the points, for which a move request has been made, from the other's points associated with the first user identification information to the user's own points associated with the second user identification information and stores the points in said database.

9. The server according to claim 8, wherein
when the first user identification information, the second user identification information, and the number of the points to he moved are received from said communication terminal, said point operation section subtracts the number of the received points from the received points of the other's points associated with first user identification information and stores the number of resultant points in said database as the other's points associated with the first user identification information; said point operation section searches said database for the received second user identification information; if the second user identification information is found in said database, said point operation section adds the number of points received from said communication terminal to the number of points of the user's own points associated with the found second user identification information and stores the number of added points in said database as the user's own points associated with the second user identification information; and if the second user identification information is not found in said database, said point operation section stores the second user identification information and the number of points received from said communication terminal in said database as user's own points in association with each other.

10. A point assignment method for use in a communication system comprising a communication terminal that a user operates; and a server including a database that stores, in association with user identification information for identifying the user who purchases or uses goods or services, a number of points that are assigned to the user according to the purchased or used goods or services and that can be used to purchase goods or services, wherein
said server divides the points stored in association with the user identification information into user's own points that only the user can use; and other's points that other users other than the user can use, before storing the points in said database.

11. The point assignment method according to claim 10, wherein
said communication terminal issues a request to said server to move at least some points from among the number of points of other's points stored in said database in association with first user identification information to the user's own points associated with second user identification information based on a predetermined instruction, and
when the movement request is received from said communication terminal, said server moves the number of points for which a move request has been made from the other's points associated with the first user identification information to the user's own points associated with the second user identification information to be stored in said database.

12. The point assignment method according to claim 11, wherein
when issuing the movement request, said communication terminal sends the first user identification information, the second user identification information, and the number of the points to be moved to the server;
said server subtracts the number of the received points from the number of points of the other's points associated with first user identification information received from said communication terminal and stores the number of resultant points in said database as the other's points associated with the first user identification information;
said server searches said database for second user identification information received from said communication terminal;
if the second user identification information is found in said database, said server adds the number of points received from said communication terminal to the number of points of the user's own points associated with the found second user identification information, and said server stores the number of resultant points in said database as the user's own points associated with the second user identification information; and
if the second user identification information is not found in said database, said server stores the second user identification information and the number of points received from said communication terminal in said database as the user's own points in association with each other.

13. The point assignment method according to claim 11, wherein
said communication terminal makes a request to move at least some of the number of points of the other's points stored in said database in association with the first user identification information to the user's own points associated with the second user identification information based on a preset instruction.

14. The point assignment method according to claim 11, wherein
said communication terminal makes a request to move at least some of the number of points of the other's points stored in said database in association with the first user identification information to the user's own points associated with the second user identification information based on an instruction inputted to said communication terminal.

15. The point assignment method according to claim 11, wherein
said communication terminal makes a request to move at least some of the number of points of the other's points stored in said database in association with the first user identification information to the user's own points associated with the second user identification information based on an instruction from a user having the second user identification information.
